(19) United States
(12) Patent Application Publication
(10) Pub. No.: US 2026/0328375 A1
(43) Pub. Date: Oct. 22, 2026

(54) INTEGRATED ACTUATOR AND LIGHT ASSEMBLY INCLUDING THE SAME

(71) Applicant: HONEYWELL INTERNATIONAL INC., Charlotte, NC (US)

(72) Inventors: Craig Giffen, Urbana, OH (US); Gerald Blair, Urbana, OH (US)

(73) Assignee: HONEYWELL INTERNATIONAL INC., Charlotte, NC (US)

(21) Appl. No.: 19/184,733

(22) Filed: Apr. 21, 2025

(51) Int. Cl. F21V 21/30; F21V 21/15; F21S 41/657; F21Y 115/10; F21Y 115/20

(52) U.S. Cl. CPC F21V 21/30; F21V 21/15; F21S 41/657; F21Y 2115/10; F21Y 2115/20

(57) ABSTRACT

An integrated actuator includes a housing, an output shaft, and an actuator assembly. The output shaft is disposed partially within, and extends from, the housing, and receives a shaft drive torque. The actuator assembly is disposed within the housing and supplies the shaft drive torque to the output shaft. The actuator assembly includes a motor, a first worm drive, a second worm drive, and an output mechanism. The motor at least selectively supplies a motor output torque. The first worm drive receives the motor output torque and supplies a first worm drive output torque. The second worm drive receives the first worm drive output torque from the first worm drive and supplies a second worm drive output torque. The output mechanism receives the second worm drive output torque and, in response, rotates about a first rotational axis and supplies the shaft drive torque to the output shaft.

### TECHNICAL FIELD

The present disclosure generally relates to actuators, and more particularly to an integrated actuator and a light assembly that includes the integrated actuator.

### BACKGROUND

Many light assemblies, most notably those used for search and/or landing lights, include motor driven actuators. These actuators are typically multistage actuators, which means there are multiple gear reductions from motor input to final drive output. With many of these multistage actuators, the final stage is implemented using a sector gear that is exposed to the elements or a gearbox that does not fit within a standard size envelope and is thus also exposed to the elements. Such exposure can limit the service life of the light assembly. In addition, presently configured actuators do not provide a method of mechanical speed control nor supply sufficient torque so that the search/landing light can be extended during flight at elevated speeds.

Hence, there is a need for an actuator that is compact enough to fit within a standard envelope, provides mechanical speed control, and supplies sufficient torque to extend the search/landing light at elevated speeds during flight. The present disclosure addresses at least these needs.

### BRIEF SUMMARY

This summary is provided to describe select concepts in a simplified form that are further described in the Detailed Description. This summary is not intended to identify key or essential features of the claimed subject matter, nor is it intended to be used as an aid in determining the scope of the claimed subject matter.

In one embodiment, an integrated actuator includes a housing, an output shaft, and an actuator assembly. The output shaft is disposed partially within, and extends from, the housing, and is coupled to receive a shaft drive torque. The actuator assembly is disposed within the housing and is configured to supply the shaft drive torque to the output shaft. The actuator assembly includes a motor, a first worm drive, a second worm drive, and an output mechanism. The motor is configured to at least selectively supply a motor output torque. The first worm drive is coupled to receive the motor output torque and supply a first worm drive output torque. The second worm drive is coupled to receive the first worm drive output torque from the first worm drive and supply a second worm drive output torque. The output mechanism is coupled to receive the second worm drive output torque and, in response, to rotate about a first rotational axis and supply the shaft drive torque to the output shaft.

In another embodiment, an adjustable light assembly includes a light engine and an integrated actuator. The integrated actuator is coupled to the light engine and is configured to supply an output torque to the light engine. The integrated actuator includes a housing, an output shaft, and an actuator assembly. The output shaft is disposed partially within, and extends from, the housing, and is coupled to receive a shaft drive torque and supply the output torque to the light engine. The actuator assembly is disposed within the housing and is configured to supply the shaft drive torque to the output shaft. The actuator assembly includes a motor, a first worm drive, a second worm drive, and an output mechanism. The motor is configured to at least selectively supply a motor output torque. The first worm drive is coupled to receive the motor output torque and supply a first worm drive output torque. The second worm drive is coupled to receive the first worm drive output torque from the first worm drive and supply a second worm drive output torque. The output mechanism is coupled to receive the second worm drive output torque and, in response, to rotate about a first rotational axis and supply the shaft drive torque to the output shaft.

In yet another embodiment, an integrated actuator includes a housing, an output shaft, and an actuator assembly. The output shaft is disposed partially within, and extends from, the housing, and is coupled to receive a shaft drive torque. The actuator assembly is disposed entirely within the housing and is configured to supply the shaft drive torque to the output shaft. The actuator assembly includes a motor, a first worm drive, a second worm drive, and an output mechanism. The motor is configured to at least selectively supply a motor output torque. The first worm drive is coupled to receive the motor output torque and supply a first worm drive output torque. The second worm drive coupled to receive the first worm drive output torque from the first worm drive and supply a second worm drive output torque. The output mechanism is coupled to receive the second worm drive output torque and, in response, to rotate about a rotational axis and supply the shaft drive torque to the output shaft. The output mechanism includes a slide bearing and a drive arm. The sliding bearing is coupled to the second worm gear assembly. The drive arm is coupled to, and extends perpendicularly from, the output shaft. The drive arm extends axially through the slide bearing, wherein the slide bearing is configured, in response to the second worm drive output torque, to rotate about the rotational axis and move axially along the drive arm and supply the shaft drive torque to the output shaft via the drive arm.

Furthermore, other desirable features and characteristics of the integrated actuator and light assembly will become apparent from the subsequent detailed description and the appended claims, taken in conjunction with the accompanying drawings and the preceding background.

### BRIEF DESCRIPTION OF DRAWINGS

The present disclosure will hereinafter be described in conjunction with the following drawing figures, wherein like numerals denote like elements, and wherein:

FIG. 1 depicts a simplified functional block diagram of one embodiment of a light assembly;

FIG. 2 depicts a perspective view of one embodiment of an integrated actuator that may be used with the light assembly of FIG. 1;

FIG. 3 depicts a perspective detailed view of an actuator assembly included in the integrated actuator of FIG. 2; and

FIGS. 4-6 depict perspective detailed views of the actuator assembly of the integrated actuator within its housing and illustrating the operation of the integrated actuator.

### DETAILED DESCRIPTION

The following detailed description is merely exemplary in nature and is not intended to limit the invention or the application and uses of the invention. As used herein, the word “exemplary” means “serving as an example, instance, or illustration.” Thus, any embodiment described herein as “exemplary” is not necessarily to be construed as preferred or advantageous over other embodiments. All of the embodiments described herein are exemplary embodiments provided to enable persons skilled in the art to make or use the invention and not to limit the scope of the invention which is defined by the claims. Furthermore, there is no intention to be bound by any expressed or implied theory presented in the preceding technical field, background, brief summary, or the following detailed description.

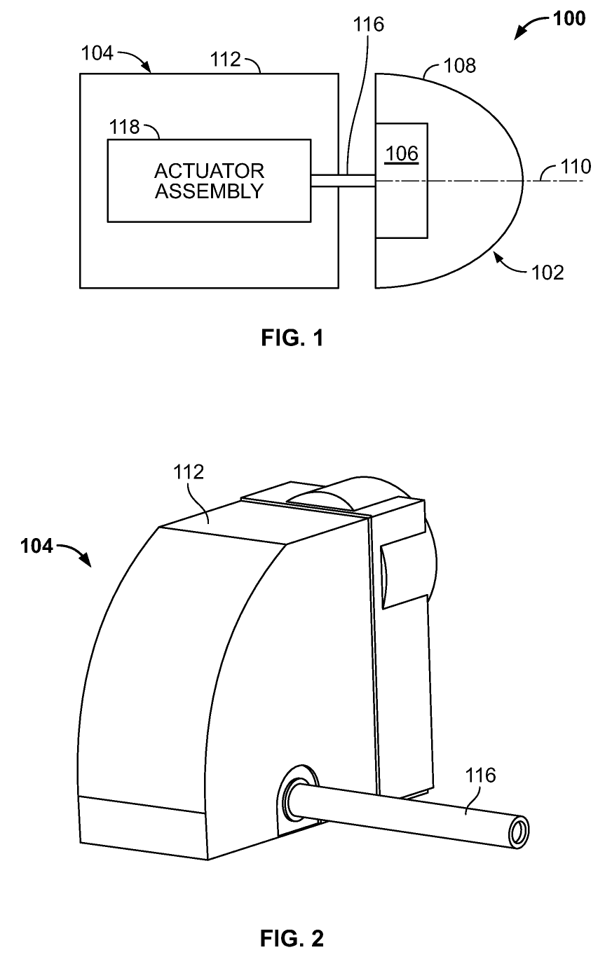

Referring to FIG. 1, a simplified functional block diagram of one embodiment of a light assembly 100 is depicted. The light assembly 100 may be adapted to be mounted on a vehicle, such as an automobile, a marine vessel, or an aircraft, and may be used as a headlight, a search light, a landing light, or a navigation light, just to name a few non-limiting examples. Regardless of the vehicle and its end-use, the depicted light assembly 100 includes a light engine 102 and an integrated actuator 104.

The light engine 102 may be variously configured and implemented. For example, the light assembly may include any one of numerous types of light sources 106 and any one of numerous suitable optics (e.g., one or more lenses) 108. It will be appreciated that the light source(s) 106 may be implemented using laser light sources, light emitting diodes (LEDs), light-emitting electrochemical cells, electroluminescent components, lamps, or any other suitable light emitting devices, just to name a few.

No matter how the light engine 102 is specifically configured and implemented, the integrated actuator 104 is coupled to the light engine 102 and is configured to supply an output torque to the light engine 102. As may be appreciated, the light engine 102, in response to the output torque, rotates about a first rotational axis 110. The integrated actuator 104 may also be variously configured and implemented. In one particular physical embodiment, which is depicted in FIG. 2, the integrated actuator includes a housing 112, an output shaft 116, and an actuator assembly 118 (not shown in FIG. 2).

The output shaft 116 is disposed partially within, and extends from, the housing 112. The output shaft 116 is coupled to receive a shaft drive torque and, in response, supplies the output torque to the light engine 102. The actuator assembly 118 is disposed within the housing 112, and more specifically entirely within the housing 112, and is configured to supply the shaft drive torque to the output shaft 116.

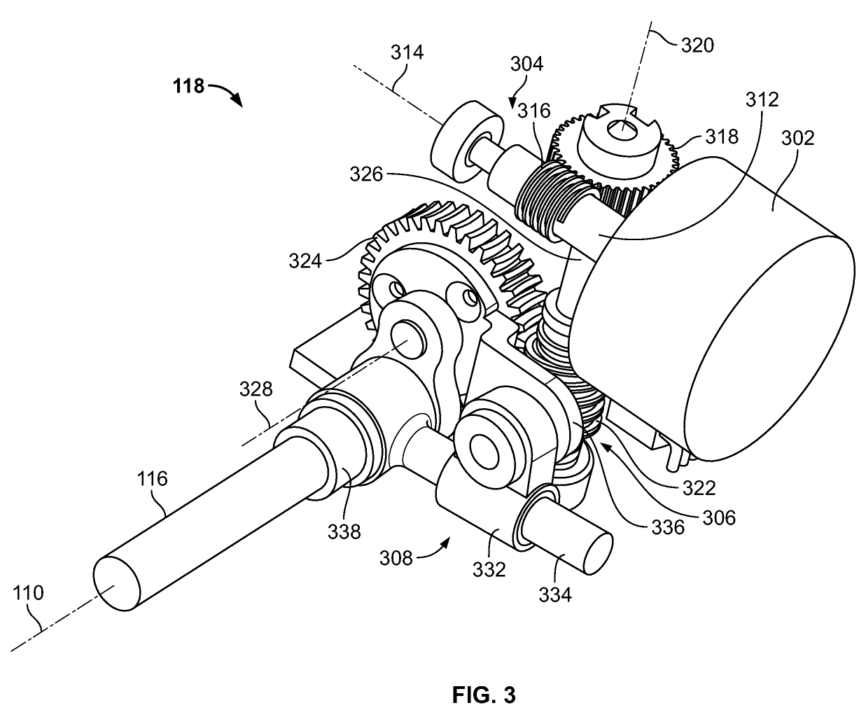

The actuator assembly 118, which is depicted in more detail in FIG. 3, includes a motor 302, a first worm drive 304, a second worm drive 306, and an output mechanism 308. The motor 302 is configured to at least selectively supply a motor output torque. More specifically, the motor 302, upon being electrically energized, supplies the motor output torque to the first worm drive 304, via a motor output shaft 312 that is rotatable about a second rotational axis 314. As FIG. 3 depicts, the second rotational axis 314 is perpendicular to the first rotational axis 110.

The first worm drive 304 is coupled to receive the motor output torque from the motor 302 and, in response, supplies a first worm drive output torque. Although the first worm drive 304 may be variously configured and implemented, in the depicted embodiment it includes a first worm screw 316 and a first worm gear 318. The first worm screw 316, at least in the depicted embodiment, is integrally formed on the motor output shaft 312. In other embodiments, however, the first worm screw 316 could be formed separate from the motor output shaft 312, and then coupled to the motor output shaft 312. In either case, it is seen that the first worm gear 318 is meshed with the first worm screw 316. With this configuration, it is additionally seen that, when the motor output shaft 312 rotates, the first worm screw 316 also rotates, with the motor output shaft 312, about the second rotational axis 314. The first worm gear 318, in response to rotation of the first worm screw 316, rotates about a third rotational axis 320 that is perpendicular to the first and second rotational axes 110, 314.

The second worm drive 306 is coupled to receive the first worm drive output torque from the first worm drive 304 and, in response, supplies a second worm drive output torque. Although the second worm drive 306 may be variously configured and implemented, in the depicted embodiment it includes a second worm screw 322 and a second worm gear 324. The second worm screw 322, at least in the depicted embodiment, is coupled to the first worm gear 318. More specifically, the second worm screw 322 is integrally formed on a second worm screw shaft 326 that is coupled to, and rotates with, the first worm gear 318. In other embodiments, the second worm screw 322 could be formed separate from the second worm screw shaft 326, and then coupled to the second worm screw shaft 326. In either case, it is seen that the second worm gear 324 is meshed with the second worm screw 322. With this configuration, it is additionally seen that the second worm screw 322 rotates, in response to rotation of the first worm gear 318, about the third rotational axis 320, and the second worm gear 324 rotates, in response to rotation of the second worm screw 322, about a fourth rotational axis 328 that is parallel to the first rotational axis 110 and perpendicular to the second and third rotational axes 314, 320.

Turning now to the output mechanism 308, it is coupled to receive the second worm drive output torque from the second worm drive 306. In response to the second worm drive output torque, the output mechanism 308 rotates, about the first rotational axis 110, and supplies the shaft drive torque to the output shaft 116. To implement this functionality, the output mechanism 308 includes a slide bearing 332 and a drive arm 334. The slide bearing 332 is coupled to the second worm drive 306. More specifically, at least in the depicted embodiment, the slide bearing 332 is coupled to the second worm gear 324 via a flange 336 that is coupled to the slide bearing 332 and the second worm gear 324.

The drive arm 334 is coupled, via suitable hardware 338, to the output shaft 116. The drive arm 334 extends perpendicularly from the output shaft 116 and extends axially through the slide bearing 332.

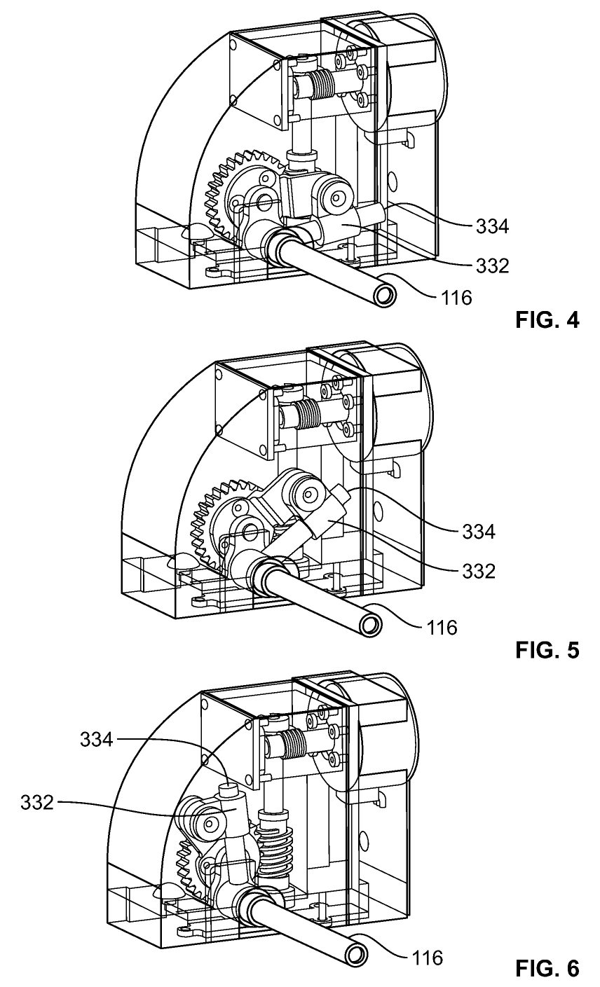

With the above-described configuration of the output mechanism B, and as illustrated most clearly in FIGS. 4-6, the slide bearing 332, in response to the second worm drive output torque, rotates about the first rotational axis 110 and moves axially along the drive arm 334, thereby supplying the shaft drive torque to the output shaft 116 via the drive arm 334.

The integrated actuator 104 described herein provides several improvements over presently known actuators. One advantage is that the output mechanism 308 amplifies the torque of the preceding stages. This allows the light engine to be extended during operations a relatively high speeds. Another advantage is that the configuration of the actuator assembly 118 is compact enough to fit within a standard size-envelope. Yet another advantage is that the configuration of the actuator assembly 118 allows for mechanical speed control, which in turn allows the light engine 102 to move favorably compared to presently known light assemblies. The mechanical speed control smooths the movement of the light engine 102 at extended angles, where relatively small movements of the light engine 102 would produce, for example, large movements of the lighting pattern on the ground.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical.

Furthermore, depending on the context, words such as “connect” or “coupled to” used in describing a relationship between different elements do not imply that a direct physical connection must be made between these elements. For example, two elements may be connected to each other physically, electronically, logically, or in any other manner, through one or more additional elements.

As used herein, the term “axial” refers to a direction that is generally parallel to or coincident with an axis of rotation, axis of symmetry, or centerline of a component or components. For example, in a cylinder or disc with a centerline and generally circular ends or opposing faces, the “axial” direction may refer to the direction that generally extends in parallel to the centerline between the opposite ends or faces. In certain instances, the term “axial” may be utilized with respect to components that are not cylindrical (or otherwise radially symmetric). For example, the “axial” direction for a rectangular housing containing a rotating shaft may be viewed as a direction that is generally parallel to or coincident with the rotational axis of the shaft. Furthermore, the term “radially” as used herein may refer to a direction or a relationship of components with respect to a line extending outward from a shared centerline, axis, or similar reference, for example in a plane of a cylinder or disc that is perpendicular to the centerline or axis. In certain instances, components may be viewed as “radially” aligned even though one or both of the components may not be cylindrical (or otherwise radially symmetric). Furthermore, the terms “axial” and “radial” (and any derivatives) may encompass directional relationships that are other than precisely aligned with (e.g., oblique to) the true axial and radial dimensions, provided the relationship is predominantly in the respective nominal axial or radial direction. As used herein, the term “substantially” denotes within 5% to account for manufacturing tolerances. Also, as used herein, the term “about” denotes within 5% to account for manufacturing tolerances.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. An integrated actuator, comprising:
a housing;
an output shaft disposed partially within, and extending from, the housing, the output shaft coupled to receive a shaft drive torque; and
an actuator assembly disposed within the housing and configured to supply the shaft drive torque to the output shaft, the actuator assembly comprising:
a motor configured to at least selectively supply a motor output torque;
a first worm drive coupled to receive the motor output torque and supply a first worm drive output torque;
a second worm drive coupled to receive the first worm drive output torque from the first worm drive and supply a second worm drive output torque; and
an output mechanism coupled to receive the second worm drive output torque and, in response, to rotate about a first rotational axis and supply the shaft drive torque to the output shaft.

2. The integrated actuator of claim 1, wherein the output mechanism comprises:
a slide bearing coupled to the second worm drive; and
a drive arm coupled to the output shaft and extending axially through the slide bearing.

3. The integrated actuator of claim 2, wherein the slide bearing is configured, in response to the second worm drive output torque, to rotate about the first rotational axis and move axially along the drive arm and supply the shaft drive torque to the output shaft via the drive arm.

4. The integrated actuator of claim 2, wherein the drive arm extends perpendicularly from the output shaft.

5. The integrated actuator of claim 1, wherein:
the motor supplies the motor output torque via a motor output shaft that is rotatable about a second rotational axis;
the output shaft, in response to receiving the shaft drive torque, rotates about the first rotational axis; and
the first rotational axis is perpendicular to the second rotational axis.

6. The integrated actuator of claim 4, wherein:
the first worm drive comprises a first worm screw and a first worm gear;
the first worm screw is coupled to, or integrally formed on, the motor output shaft; and
the first worm gear is meshed with the first worm screw.

7. The integrated actuator of claim 5, wherein:
the first worm screw rotates, with the motor output shaft, about the second rotational axis; and
the first worm gear, in response to rotation of the first worm screw, rotates about a third rotational axis that is perpendicular to the first and second rotational axes.

8. The integrated actuator of claim 6, wherein:
the second worm drive comprises a second worm screw and a second worm gear;
the second worm screw is coupled to the first worm gear; and
the second worm gear is meshed with the second worm screw.

9. The integrated actuator of claim 7, wherein:
the second worm screw rotates, in response to rotation of the first worm gear, about the third rotational axis; and
the second worm gear rotates, in response to rotation of the second worm screw, about a fourth rotational axis; and
the fourth rotational axis parallel to the first rotational axis and is perpendicular to the second and third rotational axes.

10. The integrated actuator of claim 1, wherein the motor, the first worm drive, the second worm drive, and the output mechanism are all entirely disposed within the housing.

11. An adjustable light assembly, comprising:
a light engine; and
an integrated actuator coupled to the light engine, the integrated actuator configured to supply an output torque to the light engine,
wherein the integrated actuator comprises:
a housing;
an output shaft disposed partially within, and extending from, the housing, the output shaft coupled to receive a shaft drive torque and supply the output torque to the light engine; and
an actuator assembly disposed within the housing and configured to supply the shaft drive torque to the output shaft, the actuator assembly comprising:
a motor configured to at least selectively supply a motor output torque;
a first worm drive coupled to receive the motor output torque and supply a first worm drive output torque;
a second worm drive coupled to receive the first worm drive output torque from the first worm drive and supply a second worm drive output torque; and
an output mechanism coupled to receive the second worm drive output torque and, in response, to rotate about a first rotational axis and supply the shaft drive torque to the output shaft.

12. The integrated actuator of claim 11, wherein the output mechanism comprises:
a slide bearing coupled to the second worm gear assembly; and
a drive arm coupled to the output shaft and extending axially through the slide bearing.

13. The integrated actuator of claim 12, wherein the slide bearing is configured, in response to the second worm drive output torque, to rotate about the first rotational axis and move axially along the drive arm and supply the shaft drive torque to the output shaft via the drive arm.

14. The integrated actuator of claim 12, wherein the drive arm extends perpendicularly from the output shaft.

15. The integrated actuator of claim 11, wherein:
the motor supplies the motor output torque via a motor output shaft that is rotatable about a second rotational axis;
the output shaft, in response to receiving the shaft drive torque, rotates about the first rotational axis; and
the first rotational axis is perpendicular to the second rotational axis.

16. The integrated actuator of claim 14, wherein:
the first worm drive comprises a first worm screw and a first worm gear;
the first worm screw is coupled to, or integrally formed on, the motor output shaft; and
the first worm gear is meshed with the first worm screw.

17. The integrated actuator of claim 15, wherein:
the first worm screw rotates, with the motor output shaft, about the second rotational axis; and
the first worm gear, in response to rotation of the first worm screw, rotates about a third rotational axis that is perpendicular to the first and second rotational axes.

18. The integrated actuator of claim 16, wherein:
the second worm drive comprises a second worm screw and a second worm gear;
the second worm screw is coupled to the first worm gear; and
the second worm gear is meshed with the second worm screw.

19. The integrated actuator of claim 7, wherein:
the second worm screw rotates, in response to rotation of the first worm gear, about the third rotational axis; and
the second worm gear rotates, in response to rotation of the second worm screw, about a fourth rotational axis; and
the fourth rotational axis parallel to the first rotational axis and is perpendicular to the second and third rotational axes.

20. An integrated actuator, comprising:
a housing;
an output shaft disposed partially within, and extending from, the housing, the output shaft coupled to receive a shaft drive torque; and
an actuator assembly disposed entirely within the housing and configured to supply the shaft drive torque to the output shaft, the actuator assembly comprising:
a motor configured to at least selectively supply a motor output torque;
a first worm drive coupled to receive the motor output torque and supply a first worm drive output torque;
a second worm drive coupled to receive the first worm drive output torque from the first worm drive and supply a second worm drive output torque; and
an output mechanism coupled to receive the second worm drive output torque and, in response, to rotate about a rotational axis and supply the shaft drive torque to the output shaft, the output mechanism comprising:
a slide bearing coupled to the second worm gear assembly, and
a drive arm coupled to, and extending perpendicularly from, the output shaft, the drive arm extending axially through the slide bearing,
wherein the slide bearing is configured, in response to the second worm drive output torque, to rotate about the rotational axis and move axially along the drive arm and supply the shaft drive torque to the output shaft via the drive arm.
